(19) United States
(12) Patent Application Publication
(10) Pub. No.: US 2020/0305434 A1
(43) Pub. Date: Oct. 1, 2020

(54) MIXTURES OF TERPENDOLES AND PESTICIDES AND USES THEREOF

(71) Applicant: Valent BioSciences LLC, Libertyville, IL (US)

(72) Inventors: Deanna D. Branscome, Lake Villa, IL (US); Russell Eldridge, Libertyville, IL (US); Daniel Zommick, Grayslake, IL (US)

(21) Appl. No.: 16/827,966

(22) Filed: Mar. 24, 2020

Related U.S. Application Data
(60) Provisional application No. 62/823,025, filed on Mar. 25, 2019.

(51) Int. Cl. A01N 43/90

(52) U.S. Cl. CPC A01N 43/90

(57) ABSTRACT

The present invention is directed to pesticidal mixtures comprising at least one terpendole and at least one pesticide listed in paragraph [027] of this application and methods of controlling pests by application of pesticidal mixtures comprising at least one terpendole and at least one pesticide listed in paragraph [027] of this application.

### FIELD OF THE INVENTION

The present invention is directed to pesticidal mixtures comprising at least one terpendole and at least one pesticide listed below in paragraph [027] and methods of controlling pests by application of pesticidal mixtures comprising at least one terpendole and at least one pesticide listed below in paragraph [027].

### BACKGROUND OF THE INVENTION

Arthropod pests are major threats to human welfare and exert continued stress on the food supply and transmit a broad array of medical and veterinary diseases. Synthetic pesticides played a significant role and, in many ways, ushered in modern agriculture and pest control. However, the widespread use of synthetic pesticides also created numerous environmental challenges. The acute effects of synthetic pesticides on professional applicators and other end users are well-known but the chronic long-term human health effects can be equally serious. Further, the use of synthetic pesticides has led to the development of resistant pest populations. Pesticide resistance is a complex phenomenon underlined by a diverse array of physiological mechanisms. Major mechanisms that are responsible for the development of pesticide resistance are metabolic detoxification, target site mutation, reduced cuticular penetration and behavioral avoidance.

Integrated Pest Management (“IPM”) is a holistic approach to pest management. A fundamental aspect of insecticide utilization under the broader framework of IPM is the management of insecticide resistance (IRM) by the utilization of insecticide combinations that reduce the rate of resistance development. A combination of insecticides with different modes of action is fundamentally a concept based upon the idea of redundant killing of target insects. Insects adapted to one of the active ingredient in the combination product will still be killed by the other active ingredient. Mixtures can also reduce the amount of pesticides applied in the environment and the environmental impact associated with pesticide applications.

Indole-diterpenes are a natural, structurally diverse group of secondary metabolites with a common cyclic diterpene backbone derived from geranylgeranyl diphosphate and an indole group derived from indole-3-glycerol phosphate. Terpendoles are a specific class of indole-diterpene alkaloids produced by fungi that were first discovered by Huang et al. when screening for acyl-CoA:cholesterol acyltransferase inhibitors. Huang et al. Terpendoles, Novel ACAT inhibitors produced by Albophoma yamanashiensis I. production, isolation and biological properties, J Antibiot (Tokyo). 1995 January, 48(1), 1-4. Specifically, Huang et al. discovered terpendoles A-D. Since that time, 10 additional terpendoles have been described in the literature and termed terpendoles E-M. To date, terpendoles have been further discovered to inhibit motor activation of mitotic kinesin Eg5. See, Nakazawa J. et al., A novel action of terpendole E on the motor activity of mitotic Kinesin Eg5, Chem Biol, 2003 February, 10(2), 131-137. Due to its role in inhibition mitotic kinesin, terpendole E is currently being researched as a possible anti-cancer drug. However, there is no publicly known application of terpendoles that would benefit humans.

Thus, there is a need in the art for pesticide combinations that contain naturally derived pesticides that decrease health concerns to humans and also decrease the risk of the development of pesticide resistance.

### SUMMARY OF THE INVENTION

In one aspect, the present invention is directed to pesticidal mixtures of at least one terpendole and at least one pesticide listed below in paragraph [027].

In another aspect, the present invention is directed to methods of controlling pests comprising applying an effective amount of a mixture of at least one terpendole and at least one pesticide listed below in paragraph [027].

In another aspect, the present invention is directed pesticidal mixtures of at least one

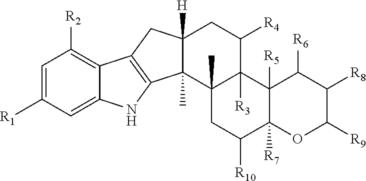

compound having the following chemical structure and at least one pesticide listed below in paragraph [027].

In another aspect, the present invention is directed to methods of controlling pests comprising applying an effective amount of a mixture of at least one compound having the following chemical structure

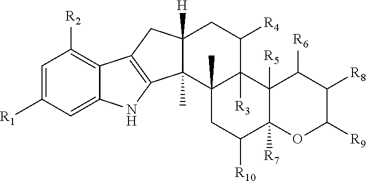

and at least one pesticide listed below in paragraph [027].

### DETAILED DESCRIPTION OF THE INVENTION

According to the present invention terpendoles are an effective pesticide. This discovery is unexpected as no known use for terpendoles had previously been discovered.

As used herein “terpendole A” refers to the following structure

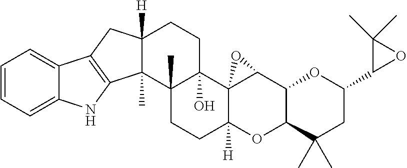

with CAS number 156967-64-5.

As used herein “terpendole B” refers to the following structure

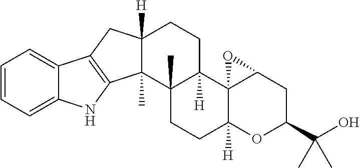

with CAS number 156967-67-8.

As used herein “terpendole C” refers to the following structure

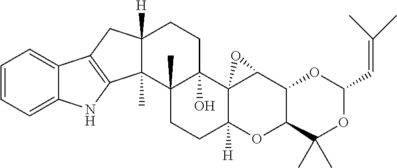

with CAS number 156967-65-6.

As used herein “terpendole D” refers to the following structure

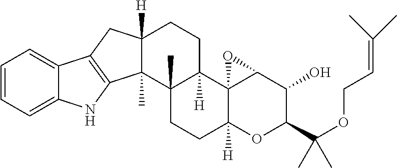

with CAS number 156967-66-7.

As used herein “terpendole E” refers to the following structure

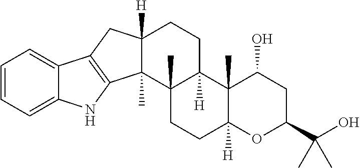

with CAS number 167427-23-8.

As used herein “terpendole F” refers to the following structure

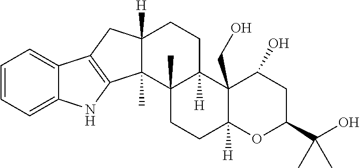

with CAS number 167427-24-9.

As used herein “terpendole G” refers to the following structure

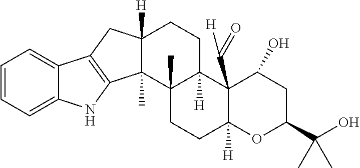

with CAS number 167427-25-0.

As used herein “terpendole H” refers to the following structure

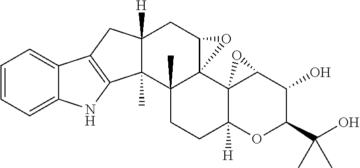

with CAS number 156967-69-0.

As used herein “terpendole I” refers to the following structure

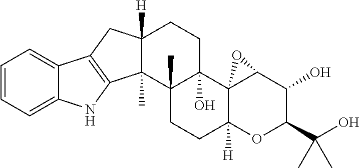

with CAS number 167612-17-1.

As used herein “terpendole J” refers to the following structure

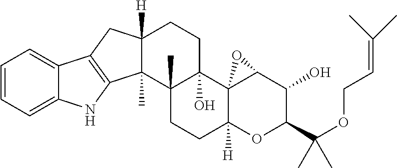

with CAS number 167427-26-1.

As used herein “terpendole K” refers to the following structure

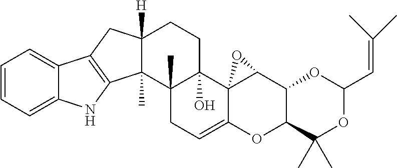

with CAS number 167427-27-2.

As used herein “terpendole L” refers to the following structure

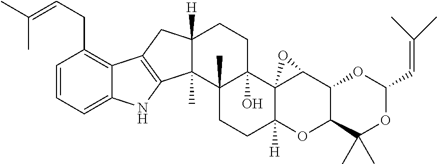

with CAS number 167612-18-2.

As used herein “terpendole M” refers to the following structure

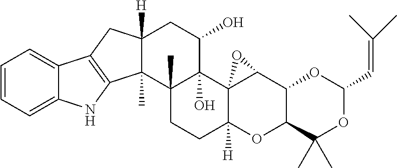

with CAS number 222400-32-0.

As used herein “terpendole N” refers to the following structure

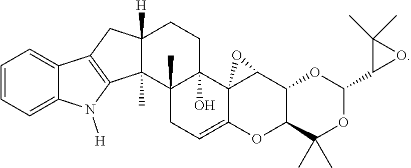

As used herein “terpendole 0” refers to the following structure

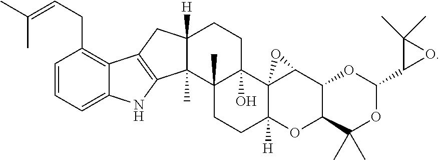

As used herein “terpendole P” refers to the following structure

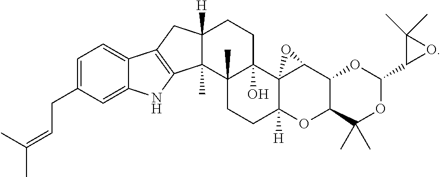

Pesticides suitable for use in the present invention are limited to the following: acetylcholinesterase (“AChE”) inhibitors including, but not limited to, carbamates such as alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, xmc, xylylcarb and organophosphates such as acephate, azamethiphos, azinphos-ethyl, azinphos-methyl, cadusafos, chlorethoxyfos, chlorfenvinphos, chlormephos, chlorpyrifos, chlorpyrifos-methyl, coumaphos, cyanophos, demeton-s-methyl, diazinon, dichlorvos/ddvp, dicrotophos, dimethoate, dimethylvinphos, disulfoton, epn, ethion, ethoprophos, famphur, fenamiphos, fenitrothion, fenthion, fosthiazate, heptenophos, isofenphos, isoxathion, malathion, mecarbam, methamidophos, methidathion, mevinphos, monocrotophos, naled, omethoate, oxydemeton-methyl, parathion, parathion-methyl, phenthoate, phosalone, phorate, phosmet, phosphamidon, phoxim, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion, pirimiphos-methyl, imicyafos, isopropyl o-(methoxyaminothio-phosphoryl) salicylate; gamma-amino butyric acid (“GABA”)-gated chloride channel blockers including but not limited to cyclodiene organochlorines such as chlordane and endosulfan; fiproles (phenylpyrazoles), including, but not limited to, ethiprole, fipronil, flufiprole, pyrafluprole and pyriprole; diamides including, but not limited to, chlorantraniliprole, cyantraniliprole, cyclaniliprole and flubendiamide; GABA-gated chloride channel allosteric modulators such as meta-diamides and isoxazolines including, but not limited to, broflanilide and fluxametamide; sodium channel modulators including, but not limited to, pyrethroids, including, but not limited to, acrinathrin, allethrin, d-cis-trans allethrin, d-trans allethrin, bifenthrin, lethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, delta-methrin, empenthrin, esfenvalerate, etofenprox, fenpropathrin, fenvalerate, flucythrinate, flumethrin, tau-fluvalinate, halfenprox, imiprothrin, meperfluthrin, metofluthrin, momfluorothrin, permethrin, phenothrin, prallethrin, profluthrin, pyrethrin (pyrethrum), res-methrin, silafluofen, tefluthrin, tetramethylfluthrin, tetramethrin, tralomethrin and transfluthrindichlorodiphenyltrichloroethane, (“DDT”) and methoxychlor; nicotinic acetylcholine receptor (“nAChR”) competitive modulators including, but not limited to, neonicotinoids, including acetamiprid, clothianidin, dinotefuran, imidacloprid, nitenpyram, thiacloprid and thiamethoxam, butenolides such as flupyradifurone, zwitterionics such as dicloromezotiaz and triflumezopyrim, sulfoximines such as sulfoxaflor and nicotine; Nicotinic acetylcholine receptor allosteric activators from the class of spinosyns, including spinosad or spinetoram; Chloride channel activators from the class of avermectins and milbemycins, including, but not limited to abamectin, emamectin benzoate, ivermectin, lepimectin or milbemectin; Juvenile hormone mimics, such as juvenile hormone analogues as hydroprene, kinoprene and methoprene; or others such as fenoxycarb or pyriproxyfen; alkylhalides such as methyl bromide; fluorides such as cryolite and sulfuryl fluoride; borates such as borax, boric acid, disodium octaborate, sodium borate and sodium metaborate; methyl isothiocyanate generators such as dazomet and metam; chloropicrin; tartar emetic; chordotonal organ transient receptor potential (“TRP”) channel modulators including, but not limited to, pyridine, azomethine derivatives such as pymetrozine; Microbial disruptors of insect midgut membranes, for example Bacillus thuringiensis or Bacillus sphaericus and the insecticdal proteins they produce such as Bacillus thuringiensis subsp. israelensis, Bacillus sphaericus, Bacillus thuringiensis subsp. aizawai, Bacillus thuringiensis subsp. kurstaki and Bacillus thuringiensis subsp. tenebrionis, or the Bt crop proteins: Cry1Ab, Cry1Ac, Cry1Fa, Cry2Ab, mCry3A, Cry3Ab, Cry3Bb and Cry34/35Ab1; inhibitors of mitochondrial adenosine triphosphate (“ATP”) synthase including, but not limited to, organotin miticides such as azocyclotin, cyhexatin and fenbutatin oxide and diafenthiruon, propargite and tetradifon; uncouplers of oxidative phosphorylation via disruption of the proton gradient such as chlorfenapyr, dinitro-ortho-cresol (“DNOC”) and sulfuramide; nAChR channel blockers including, but not limited to, nereistoxin analogues such as bensultap, cartap hydrochloride, thiocyclam and thiosultap-sodium; Inhibitors of the chitin biosynthesis type 0, such as benzoylureas as for example bistrifluron, chlorfluazuron, diflubenzuron, flucycloxuron, flufenoxuron, hexaflumuron, lufenuron, novaluron, noviflumuron, teflubenzuron or triflumuron; Inhibitors of the chitin biosynthesis type 1, as for example buprofezin; Moulting disruptors, Dipteran, as for example cyromazine; Ecdyson receptor agonists such as diacylhydrazines, for example methoxyfenozide, tebufenozide, halofenozide, fufenozide or chromafenozide; octopamine receptor agonists such as amitraz; mitochondrial complex III electron transport inhibitors (“METI III”) such as acequinocyl, bifenazate and fluacrypyrim, hydramethylnon; mitochondrial complex I electron transport inhibitors (“METI I”) such as fenazaquin, pyrimidifen, pyridaben, tebufenpyrad and rotenone; voltage-dependent sodium channel blockers including, but not limited to, oxadiazines such as indoxacarb and semicarbazones such as metaflumizone; inhibitors of acetyl coenzyme (“CoA”) carboxylase including, but not limited to, tetronic and tetramic acid derivatives such as spirodiclofen and spiromesifen and spirotetramat; mitochondrial complex IV electron transport inhibitors (“METI IV”) including, but not limited to, phosphides such as aluminum phosphide, calcium phosphide, phosphine and zinc phosphide and cyanides such as calcium cyanide, potassium cyanide, sodium cyanide; mitochondrial complex II electron transport inhibitors (“METI II”) including, but not limited to, beta-ketonitrile derivatives such as cyenopyrafen and cyflumetofen and carboxanilides such as pyflubumide; isoxazolines such as afoxolaner, fluralaner, lotilaner and sarolaner; pyropenes such as afidopyropen; other compounds of an unclassified nature such as benzoximate; bromoproylate; chinomethionat; dicofol; GS-omega/kappa HXTX-HV1A peptide; lime sulfur; sulfur; acynonapyr; flometoquin; spiroindoline; growth inhibitors including clofentezine, diflovidazin, hexythiazox, etoxazole; sabadilla including sabadilla oil and sabadilla alkaloids including veratridine and cevadine; and insecticidal active compounds of unknown or uncertain mode of action, as for example afidopyropen, azadirachtin, amidoflumet, benzoximate, bifenazate, bromopropylate, chinomethionat, cryolite, dicofol, flufenerim, flometoquin, fluensulfone, flupyradifurone, piperonyl butoxide, pyridalyl, pyrifluquinazon, sulfoxaflor, pyflubumide or the compounds 4-[5-(3,5-Dichloro-phenyl)-5-trifluoromethyl-4,5-dihydro-isoxazol-3-yl]-2-methyl-N-[(2,2,2-trifluoro-ethylcarbamoyl)-methyl]-benzamide, or the compound cyclopropaneacetic acid, 1,1′-[(3 S,4R,4aR,6S,6aS,12R,12aS,12b S)-4-[[(2-cyclopropylacetyl)oxy]methyl]-1,3,4,4a,5,6,6a,12,12a,12b-decahydro-12-hydroxy-4,6a,12b-trimethyl-11-oxo-9-(3-pyridinyl)-2H,11H-naphtho[2,1-b]pyrano[3,4-e]pyran-3,6-diyl]ester, or the compound 11-(4-chloro-2,6-dimethylphenyl)-12-hydroxy-1,4-dioxa-9-azadispiro[4.2.4.2]-tetradec-11-en-10-one, or the compound 3-(4′-fluoro-2,4-dimethylbiphenyl-3-yl)-4-hydroxy-8-oxa-1-azaspiro[4.5]dec-3-en-2-one, or the compound 1-[2-fluoro-4-methyl-5-[(2,2,2-trifluoroethyl)sulfinyl]phenyl]-3-(trifluoromethyl)-1H-1,2,4-triazole-5-amine, or actives on basis of Bacillus firmus (Votivo, 1-1582), or a compound selected from the group of (E/Z)—N-[1-[(6-chloro-3-pyridyl)methyl]-2-pyridylidene]-2,2,2-trifluoro-acetamide; (E/Z)—N-[1-[(6-chloro-5-fluoro-3-pyridyl)methyl]-2-pyridylidene]-2,2,2-trifluoro-acetamide; (E/Z)-2,2,2-trifluoro-N-[1-[(6-fluoro-3-pyridyl)methyl]-2-pyridylidene]acetamide; (E/Z)—N-[1-[(6-bromo-3-pyridyl)methyl]-2-pyridylidene]-2,2,2-trifluoro-acetamide; (E/Z)—N-[1-[1-(6-chloro-3-pyridyl)ethyl]-2-pyridylidene]-2,2,2-trifluoro-acetamide; (E/Z)—N-[1-[(6-chloro-3-pyridyl)methyl]-2-pyridylidene]-2,2-difluoro-acetamide; (E/Z)-2-chloro-N-[1-[(6-chloro-3-pyridyl)methyl]-2-pyridylidene]-2,2-difluoro-acetamide; (E/Z)—N-[1-[(2-chloropyrimidin-5-yl)methyl]-2-pyridylidene]-2,2,2-trifluoro-acetamide and (E/Z)—N-[1-[(6-chloro-3-pyridyl)methyl]-2-pyridylidene]-2,2,3,3,3-pentafluoro-propanamide); or triflumezopyrim; or 4-[5-[3-chloro-5-(trifluoromethyl)phenyl]-5-(trifluoromethyl)-4H-isoxazol-3-yl]-N-[2-oxo-2-(2,2,2-trifluoroethylamino)ethyl]naphthalene-1-carboxamide, or 8-chloro-N-[2-chloro-5-methoxyphenyl)sulfonyl]-6-trifluoromethyl)-imidazo[1,2-a]pyridine-2-carboxamide; or 4-[5-(3,5-dichlorophenyl)-5-(trifluoromethyl)-4H-isoxazol-3-yl]-2-methyl-N-(1-oxothietan-3-yl)benzamide; or 5-[3-[2,6-dichloro-4-(3,3-dichloroallyloxyl)phenoxy]propoxy]-1H-pyrazole; acaricides including, but not limited to, 1,1-bis(4-chlorophenyl)-2-ethoxyethanol, 2,4-dichlorophenyl benzenesulfonate, 2-fluoro-N-methyl-N-1-naphthylacetamide, 4-chlorophenyl phenyl sulfone, abamectin, acequinocyl, acetoprole, acrinathrin, aldicarb, aldoxycarb, alpha-cypermethrin, amidithion, amidoflumet, amidothioate, amiton, amiton hydrogen oxalate, amitraz, aramite, arsenous oxide, AVI 382, AZ 60541, azinphos-ethyl, azinphos-methyl, azobenzene, azocyclotin, azothoate, benomyl, benoxafos, benzoximate, benzyl benzoate, bifenazate, bifenthrin, binapacryl, brofenvalerate, bromocyclen, bromophos, bromophos-ethyl, bromopropylate, buprofezin, butocarboxim, butoxycarboxim, butylpyridaben, calcium polysulfide, camphechlor, carbanolate, carbaryl, carbofuran, carbophenothion, CGA 50′439, chino-methionat, chlorbenside, chlordimeform, chlordimeform hydrochloride, chlorfenapyr, chlorfenethol, chlorfenson, chlorfensulphide, chlorfenvinphos, chlorobenzilate, chloromebuform, chloromethiuron, chloropropylate, chlorpyrifos, chlorpyrifos-methyl, chlorthiophos, cinerin I, cinerin II, cinerins, clofentezine, closantel, coumaphos, crotamiton, crotoxyphos, cufraneb, cyanthoate, cyhalothrin, cyhexatin, cypermethrin, DCPM, DDT, demephion, demephion-O, demephion-S, demeton, demeton-methyl, demeton-O, demeton-O-methyl, demeton-S, demeton-5-methyl, demeton-5-methylsulphon, diafenthiuron, dialifos, diazinon, dichlofluanid, dichlorvos, dicliphos, dicofol, dicrotophos, dienochlor, dimefox, dimethoate, dinactin, dinex, dinex-diclexine, dinobuton, dinocap, dinocap-4, dinocap-6, dinocton, dinopenton, dinosulfon, dinoterbon, dioxathion, diphenyl sulfone, disulfiram, disulfoton, DNOC, dofenapyn, doramectin, endosulfan, endothion, EPN, eprinomectin, ethion, ethoate-methyl, etoxazole, etrimfos, fenazaflor, fenazaquin, fenbutatin oxide, fenothiocarb, fenpropathrin, fenpyrad, fenpyroximate, fenson, fentrifanil, fenvalerate, fipronil, fluacrypyrim, fluazuron, flubenzimine, flucycloxuron, flucythrinate, fluenetil, flufenoxuron, flumethrin, fluorbenside, fluvalinate, FMC 1137, formetanate, formetanate hydrochloride, formothion, formparanate, gamma-HCH, glyodin, halfenprox, heptenophos, hexadecyl cyclopropanecarboxylate, hexythiazox, iodomethane, isocarbophos, isopropyl 0-(methoxyaminothiophosphoryl)salicylate, ivermectin, j asmolin I, j asmolin II, j odfenphos, lindane, lufenuron, malathion, malonoben, mecarbam, mephosfolan, mesulfen, methacrifos, methamidophos, methidathion, methiocarb, methomyl, methyl bromide, metolcarb, mevinphos, mexacarbate, milbemectin, milbemycin oxime, mipafox, monocrotophos, morphothion, moxidectin, naled, NC-184, nifluridide, nikkomycins, nitrilacarb, nitrilacarb 1:1 zinc chloride complex, NNI-0101, NNI-0250, omethoate, oxamyl, oxydeprofos, oxydisulfoton, pp′-DDT, parathion, permethrin, petroleum oils, phenkapton, phenthoate, phorate, phosalone, phosfolan, phosmet, phosphamidon, phoxim, pirimiphos-methyl, polychloroterpenes, polynactins, proclonol, profenofos, promacyl, propargite, propetamphos, propoxur, prothidathion, prothoate, pyrethrin I, pyrethrin II, pyrethrins, pyridaben, pyridaphenthion, pyrimidifen, pyrimitate, quinalphos, quintiofos, R-1492, RA-17, rotenone, schradan, sebufos, selamectin, SI-0009, sophamide, spirodiclofen, spiromesifen, SSI-121, sulfiram, sulfluramid, sulfotep, sulfur, SZI-121, tau-fluvalinate, tebufenpyrad, TEPP, terbam, tetrachlorvinphos, tetradifon, tetranactin, tetrasul, thiafenox, thiocarboxime, thiofanox, thiometon, thioquinox, thuringiensin, triamiphos, triarathene, triazophos, triazuron, trichlorfon, trifenofos, trinactin, vamidothion, vaniliprole and YI-5302; an algicide including, but not limited to, bethoxazin, copper dioctanoate, copper sulfate, cybutryne, dichlone, dichlorophen, endothal, fentin, hydrated lime, nabam, quinoclamine, quinonamid, simazine, triphenyltin acetate and triphenyltin hydroxide; bactericides including, but not limited to, 1-hydroxy-1H-pyridine-2-thione, 4-(quinoxalin-2-ylamino)benzenesulfonamide, 8-hydroxyquinoline sulfate, bronopol, copper dioctanoate, copper hydroxide, cresol, dichlorophen, dipyrithione, dodicin, fenaminosulf, formaldehyde, hydrargaphen, kasugamycin, kasugamycin hydrochloride hydrate, nickel bis(dimethyldithiocarbamate), nitrapyrin, octhilinone, oxolinic acid, oxytetracycline, potassium hydroxyquinoline sulfate, probenazole, streptomycin, streptomycin sesquisulfate, tecloftalam and thiomersal; a chemosterilant selected from the group of substances consisting of apholate, bisazir, busulfan, diflubenzuron, dimatif, hemel, hempa, metepa, methiotepa, methyl apholate, morzid, penfluron, tepa, thiohempa, thiotepa, tretamine and uredepa; a molluscicide including, but not limited to, bis(tributyltin) oxide, bromoacetamide, calcium arsenate, cloethocarb, copper acetoarsenite, copper sulfate, fentin, ferric phosphate, metaldehyde, methiocarb, niclosamide, niclosamide-olamine, pentachlorophenol, sodium pentachlorophenoxide, tazimcarb, thiodicarb, tributyltin oxide, trifenmorph, trimethacarb, triphenyltin acetate and triphenyltin hydroxide; nematicides including, but not limited to, 1,2-dibromo-3-chloropropane, 1,2-dichloropropane, 1,2-dichloropropane with 1,3-dichloropropene, 1,3-dichloropropene, 3,4-dichlorotetrahydrothiophene 1,1-dioxide, 3-(4-chlorophenyl)-5-methylrhodanine, 5-methyl-6-thioxo-1,3,5-thiadiazinan-3-ylacetic acid, 6-isopentenylaminopurine, abamectin, acetoprole, alanycarb, aldicarb, aldoxycarb, AZ 60541, benclothiaz, benomyl, butylpyridaben, cadusafos, carbofuran, carbon disulfide, carbosulfan, chloropicrin, chlorpyrifos, cloethocarb, cytokinins, dazomet, DBCP, DCIP, diamidafos, dichlofenthion, dicliphos, dimethoate, doramectin, emamectin, emamectin benzoate, eprinomectin, ethoprophos, ethylene dibromide, fenamiphos, fenpyrad, fensulfothion, fosthiazate, fosthietan, furfural, GY-81, heterophos, iodomethane, isamidofos, isazofos, ivermectin, kinetin, mecarphon, metam, metam-potassium, metam-sodium, methyl bromide, methyl isothiocyanate, milbemycin oxime, moxidectin, Myrothecium verrucaria composition, NC-184, oxamyl, phorate, phosphamidon, phosphocarb, sebufos, selamectin, spinosad, terbam, terbufos, tetrachlorothiophene, thiafenox, thionazin, triazophos, triazuron, xylenols, YI-5302 and zeatin; Microbial pesticides with insecticidal, acaricidal, molluscidal and/or nematicidal activity: Bacillus firmus, B. thuringiensis ssp. israelensis, B. t. ssp. galleriae, B. t. ssp. kurstaki, Beauveria bassiana, Burkholderia sp., Chromobacterium subtsugae, Isaria fumosorosea, Lecanicillium longisporum, L. muscarium (formerly Verticillium lecanii), Metarhizium anisopliae, M anisopliae var. acridum, Paecilomyces fumosoroseus, P. lilacinus, Paenibacillus poppiliae, Pasteuria spp., P. nishizawae, P. reneformis, P. usagae, Pseudomonas fluorescens, Steinernema feltiae, Streptomces galbus; baculovirsues including, but not limited to, Cydia pomonella granulosis virus, Thaumatotibia leucotreta granulosis virus, Anticarsia gemmatalis MNPV, Hehcoverpa armigera NPV; and Biochemical pesticides with insecticidal, acaricidal, molluscidal, pheromone and/or nematicidal activity: L-carvone, citral, (E,Z)-7,9-dodecadien-1-yl acetate, ethyl formate, (E,Z)-2,4-ethyl decadienoate (pear ester), (Z,Z,E)-7,11,13-hexadecatrienal, heptyl butyrate, isopropyl myristate, lavanulyl senecioate, 2-methyl 1-butanol, methyl eugenol, methyl jasmonate, (E,Z)-2,13-octadecadien-1-ol, (E,Z)-2,13-octadecadien-1-ol acetate, (E,Z)-3,13-octadecadien-1-ol, R-1-octen-3-ol, pentatermanone, potassium silicate, sorbitol actanoate, (E,Z,Z)-3,8,11-tetradecatrienyl acetate, (Z,E)-9,12-tetradecadien-1-yl acetate, Z-7-tetradecen-2-one, Z-9-tetradecen-1-yl acetate, Z-11-tetradecenal, Z-11-tetradecen-1-ol, Acacia negra extract, extract of grapefruit seeds and pulp, extract of Chenopodium ambrosiodae, Catnip oil, neem oil, Quillay extract and Tagetes oil; alternatives to pesticides including insect pheromones including, but not limited to, (E)-dec-5-en-1-yl acetate with (E)-dec-5-en-1-ol, (E)-tridec-4-en-1-yl acetate, (E)-6-methylhept-2-en-4-ol, (E,Z)-tetradeca-4,10-dien-1-yl acetate, (Z)-dodec-7-en-1-yl acetate, (Z)-hexadec-11-enal, (Z)-hexadec-11-en-1-yl acetate, (Z)-hexadec-13-en-11-yn-1-yl acetate, (Z)-icos-13-en-10-one, (Z)-tetradec-7-en-1-al, (Z)-tetradec-9-en-1-ol, (Z)-tetradec-9-en-1-yl acetate, (7E,9Z)-dodeca-7,9-dien-1-yl acetate, (9Z,11E)-tetradeca-9,11-dien-1-yl acetate, (9Z,12E)-tetradeca-9,12-dien-1-yl acetate, 14-methyloctadec-1-ene, 4-methylnonan-5-ol with 4-methylnonan-5-one, alpha-multistriatin, brevicomin, codlelure, codlemone, cuelure, disparlure, dodec-8-en-1-yl acetate, dodec-9-en-1-yl acetate, dodeca-8,10-dien-1-yl acetate, dominicalure, ethyl 4-methyloctanoate, eugenol, frontalin, gossyplure, grandlure, grandlure I, grandlure II, grandlure III, grandlure IV, hexalure, ipsdienol, ipsenol, japonilure lineatin, litlure, looplure, medlure, megatomoic acid, methyl eugenol, muscalure, octadeca-2,13-dien-1-yl acetate, octadeca-3,13-dien-1-yl acetate, orfralure, oryctalure, ostramone, siglure, sordidin, sulcatol, tetradec-11-en-1-yl acetate, trimedlure, trimedlure A, trimedlure B1, trimedlure B2, trimedlure C, and trunc-call; a plant activator including, but not limited to, acibenzolar, acibenzolar-5-methyl, probenazole and Reynoutria sachalinensis extract; and a synergist including, but not limited to, 2-(2-butoxyethoxy)ethyl piperonylate, 5-(1,3-benzodioxol-5-yl)-3-hexylcyclohex-2-enone, farnesol with nerolidol, MB-599, MGK 264, piperonyl butoxide, piprotal, propyl isomer, S421, sesamex, sesasmolin and sulfoxide.

In another embodiment, the pesticide is selected from the group consisting of abamectin, imidacloprid, acetamiprid, spirodiclofen, thiamethoxam, pyriproxyfen, lambda-cyhalothrin, spiromesifen, pyridaben, etoxazole, spirotetramat, pirimicarb, bifenthrin, diafenthiuron, acephate, omethoate, flonicamid, dimethoate, sulfoxaflor, cyantraniliprole, deltamethrin, alphacypermethrin, dichlorvos(DDVP), milbemectin, cypermethrin, clothianidin, carbosulfan, betacypermethrin, buprofezin, chlorpyrifos, mineral oil, emamectin benzoate, methomyl, azadirachtin, spinetoram, esfenvalerate, malathion, zeta-cypermethrin, indoxacarb, emamectin, diflubenzuron, methoxyfenozide, fipronil, permethrin, pyrethrins, carbaryl, novaluron, Sabadilla sp., cyfluthrin, endosulfan, fatty-acids and salts of thereof, Bacillus thuringiensis and tebufenozide.

The mixtures of the present invention can be applied by any convenient means. Those skilled in the art are familiar with the modes of application including but not limited to, spraying, brushing, soaking, in-furrow treatments, drip irrigation, granule application, seed treatment, pressurized liquids (aerosols), fogging or side-dressing.

As used herein, “to control” a pest or “controlling” pest(s) refers to killing, incapacitating, repelling, or otherwise decreasing the negative impact of the pest on plants or animals to a level that is desirable to the grower, applicator or user.

As used herein, “composition” refers to one or more active ingredients in a carrier. The carrier may be a liquid, a semi-solid, a solid or a gas and may contain additional ingredients. For example, a fermentation broth is a suitable carrier for the present invention.

As used herein, “an area in need of pest control” refers to any area that the pest is present during any life stage. One environment likely to be treated by the methods of the present invention includes the plants that the pest is living on and/or the surrounding soil. The pest's environment may also include an area where plants are grown, harvested, or in gardens, fields, greenhouses, or other buildings, and various indoor surfaces and structures, such as furniture including beds, and furnishings including books, clothing, etc.

As used herein, all numerical values relating to amounts, weight percentages and the like are defined as “about” or “approximately” each particular value, namely, plus or minus 10%. For example, the phrase “about 5,000 parts per million” is to be understood as “from 4,500 to 5,500 parts per million.” Therefore, amounts within 10% of the claimed values are encompassed by the scope of the claims.

The term “effective amount” means the amount of the formulation that will control the target pest. The “effective amount” will vary depending on the mixture concentration, the type of pest(s) being treated, the severity of the pest infestation, the result desired, and the life stage of the pest during treatment, among other factors. Thus, it is not always possible to specify an exact “effective amount.” However, an appropriate “effective amount” in any individual case may be determined by one of ordinary skill in the art.

The articles “a,” “an” and “the” are intended to include the plural as well as the singular, unless the context clearly indicates otherwise. For example, the methods of the present invention are directed to controlling “pest” but this can include control of a multiple pests (such as a more than one insect or more than one insect species or more than one mite or more than one mite species).

In one embodiment, the present invention is directed to a pesticidal mixture of at least one terpendole and at least one pesticide listed above in paragraph [027].

Terpendoles include, but are not limited to, compounds having the following chemical structure

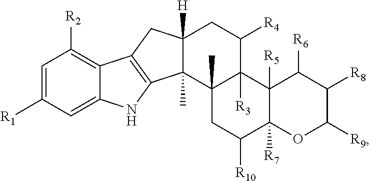

wherein:
R¹ and R² are each independently H or 2-methyl-2-butene;
R³ and R⁴ are each independently H or —OH or R³ and R⁴ are taken together to form an epoxide bridge;
R⁵ is CH₃, —CH₂—OH, or —CH═O and R⁶ is —OH or R⁵ and R⁶ are taken together to form an epoxide bridge;
R⁷ and R¹⁰ are each H or absent, wherein if R⁷ and R¹⁰ are absent then carbon atoms adjacent to R⁷ and R¹⁰ are double bonded; and
R⁸ is H or —OH and R⁹ is —C—(CH₃)₂—O—CH₂—CH═C—(CH₃)₂, —C—(CH₃)₂—OH or R⁸ and R⁹
taken together form

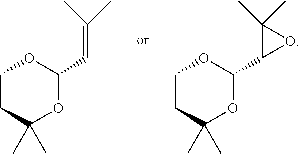

In a preferred embodiment, the at least one terpendole is selected from the group consisting of terpendole A, terpendole B, terpendole C, terpendole D, terpendole E, terpendole F, terpendole G, terpendole H, terpendole I, terpendole J, terpendole K, terpendole L, terpendole M, terpendole N, terpendole 0 and terpendole P, more preferably the at least one terpendole is selected from terpendole A, terpendole C, terpendole K, terpendole N, terpendole 0 and terpendole P.

The at least one terpendole of the present invention may be applied at a concentration from about 1 to about 10,000 parts per million (“ppm”), preferably from about 4 to about 5,000 parts per million, more preferably from about 4 to about 100 ppm.

Concentrations of the at least one pesticide listed above in paragraph [027] can be derived from common knowledge by those skilled in the art. In a preferred embodiment, the pesticidal mixtures of the present invention comprise from about 0.001% to about 10% w/w of the at least one pesticide listed above in paragraph [027].

In another embodiment, the mixture of at least one terpendole and at least one pesticide listed above in paragraph [027] are active ingredients in a composition.

Other components that enhance the biological activity or application of these ingredients may optionally be included.

In another embodiment, the mixtures of the present invention further comprise one or more excipients selected from the group consisting of solvents, anti-caking agents, stabilizers, defoamers, slip agents, humectants, dispersants, wetting agents, thickening agents, emulsifiers, penetrants, adjuvants, synergists, polymers, propellants and preservatives.

In another embodiment, the present invention is directed to a method of controlling a pest comprising applying an effective amount of a mixture of at least one terpendole and at least one pesticide listed above in paragraph [027] to the pest or an area in need of pest control.

In a preferred embodiment, the pest is an arthropod pest, more preferably an insect or a mite. As used herein, “arthropod” refers to pests that belong to the Phylum Arthropoda. As used herein, “insect” refers to pests that belong to the Class Insecta. As used herein, “mite” refers to pests that belong to the Subclass Acari of the Class Arachnida.

In another preferred embodiment, the pest is an aphid. As used herein, “aphid” refers to pests that belong to the Family Aphididae. Exemplary aphids include cotton aphid (Aphis gossypii), foxglove aphid (Aulacorthum solani), cabbage aphid (Brevicoryne brassicae), birdcherry-oat aphid (Rhopalosiphum padi) and green peach aphid (Myzus persicae).

In another preferred embodiment, the pest is a lepidopteran. As used herein, “lepidopteran” refers to pests that belong to the Order Lepidoptera including moths and their larval stages. Exemplary lepidopterans include diamondback moth (Plutella xylostella) and common cutworm (Spodoptera litura).

In another preferred embodiment, the pest is a thrips. As used herein, “thrips” refers to pests that belong to the Family Thripidae. Exemplary thrips include western flower thrips (Frankhniella occidentalis).

In another preferred embodiment, the pest is a whitefly. As used herein, “whitefly” refers to pests that belong to the Family Aleyrodidae. Exemplary whiteflies include silverleaf whitefly and tobacco whitefly (Bemisia tabaci).

In another preferred embodiment, the pest is a planthopper. As used herein, “planthopper”, refers to pests that belong to the Infraorder Fulgoromorpha of the Order Hemiptera. Exemplary planthoppers include brown rice planthopper (Nilaparvata lugens).

In another preferred embodiment, the pest belongs to the infraclass Neoptera of the Class Insecta, the Subfamily Aphidinae of the Family Aphididae or the Parvorder Heteroneura of the Family Lepidoptera.

In another preferred embodiment, the area in need of pest control is a plant.

In another preferred embodiment, the area in need of pest control is an area that includes but is not limited to, where crops are grown, harvested, stored, processed, packed or shipped.

In a preferred embodiment, terpendoles are applied to the pest or the pest's environment at a rate from about 1 to about 1,000 grams per hectare (“g/HA”), preferably from about 10 to about 700 g/HA and most preferably from about 11 to about 560 g/HA.

Application rates for the at least one pesticide listed above in paragraph [027] can be derived from common knowledge by those skilled in the art. In a preferred embodiment, the at least one pesticide listed above in paragraph [027] is applied to the pest or the pest's environment at a rate from about 1 to about 20,000 g/HA.

What is claimed is:

1. A pesticidal mixture comprising an effective amount of at least one terpendole and at least one pesticide listed in paragraph [027] of this application.

2. The mixture of claim 1, wherein the at least one terpendole is selected from the group consisting of compound (I) 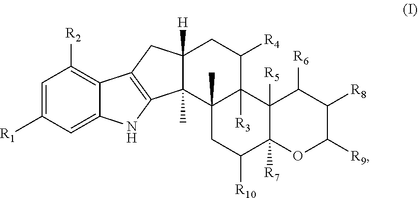
wherein:
R¹ and R² are each independently H or 2-methyl-2-butene;
R³ and R⁴ are each independently H or —OH or R³ and R⁴ are taken together to form an epoxide bridge;
R⁵ is CH₃, —CH₂—OH, or —CH═O and R⁶ is —OH or R⁵ and R⁶ are taken together to form an epoxide bridge;
R⁷ and R¹⁰ are each H or absent, wherein if R⁷ and R¹⁰ are absent then carbon atoms adjacent to R⁷ and R¹⁰ are double bonded; and
R⁸ is H or —OH and R⁹ is —C—(CH₃)₂—O—CH₂—CH═C—(CH₃)₂, —C—(CH₃)₂—OH or R⁸ and R⁹ taken together form

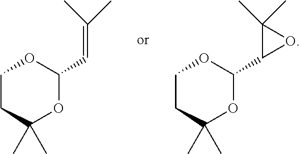

3. The mixture of claim 1, wherein the at least one terpendole is selected from the group consisting of terpendole A, terpendole B, terpendole C, terpendole D, terpendole E, terpendole F, terpendole G, terpendole H, terpendole I, terpendole J, terpendole K, terpendole L, terpendole M, terpendole N, terpendole O and terpendole P.

4. The mixture of claim 1, wherein the at least one terpendole is selected from the group consisting of terpendole A, terpendole C, terpendole K, terpendole N, terpendole O and terpendole P.

5. The mixture of claim 1, further comprising one or more excipients selected from the group consisting of solvents, anti-caking agents, stabilizers, defoamers, slip agents, humectants, dispersants, wetting agents, thickening agents, emulsifiers, penetrants, adjuvants, synergists, polymers, propellants and/or preservatives.

6. A method of controlling a pest comprising applying the mixture of claim 1 to the pest or the pest's environment.
